(19) United States
(12) Patent Application Publication
(10) Pub. No.: US 2016/0157048 A1
(43) Pub. Date: Jun. 2, 2016

(54) HANDLING BLUETOOTH LOW ENERGY MESSAGES

(71) Applicant: NOKIA TECHNOLOGIES OY, Espoo (FI)

(72) Inventors: Kanji KERAI, London (GB); Jia LIU, Beijing (CN)

(21) Appl. No.: 14/903,085

(22) PCT Filed: Jul. 24, 2013
(86) PCT No.: PCT/CN2013/080047

§ 371 Date: Jan. 6, 2016

(51) Int. Cl. H04W 4/00; H04W 8/00

(52) U.S. Cl. CPC H04W 4/008; H04W 8/005

(57) ABSTRACT

This specification describes a method comprising responding to receipt of a first Bluetooth Low Energy (BLE) advertising message, the first BLE advertising message comprising advertising data and an address of a source device from which the advertising data derived, by forming and causing transmission of a second BLE advertising message including the advertising data and the address of the source device. This specification also describes apparatuses and computer program code for causing performance of the method. The specification also describes other methods, apparatuses and computer program code relating to the above method.

### FIELD

This specification relates to handling Bluetooth Low Energy messages.

### BACKGROUND

Bluetooth Low Energy (BLE) is a new wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of classical Bluetooth, BLE redefines the physical layer specification, and involves many new features such as a very-low power idle mode, a simple device discovery, and short data packets.

BLE technology is aimed at devices requiring low power consumption, for example devices that may operate with one or more button cell batteries such as sensors, key fobs, and/or the like. BLE can also be incorporated into devices such as mobile phones, smart phones, tablet computers, laptop computers and desktop computers.

### SUMMARY

In a first aspect, this specification describes a method comprising responding to receipt of a first Bluetooth Low Energy (BLE) advertising message, the first BLE advertising message comprising advertising data and an address of a source device from which the advertising data derived, by forming and causing transmission of a second BLE advertising message including the advertising data and the address of the source device.

The method may comprise forming the second BLE advertising message by encapsulating at least the advertising data and the address of the source device.

The method may comprise including additional advertising data in a payload of the second BLE advertising message.

The method may be performed by a re-advertising device and the second BLE advertising message may include an address of the re-advertising device. The address of the re-advertising device may be included in the payload second BLE advertising message.

The method may comprise determining if the first BLE advertising message includes re-transmitted advertising data and, if it is determined that the first BLE advertising includes re-transmitted advertising data, forming a payload for the second BLE advertising message which consists of the payload of the first BLE advertising message. The method may be performed by a re-advertising device and the method may comprise, if it is determined that the first BLE advertising message does not include re-transmitted advertising data, forming a payload for the second BLE advertising message which includes the advertising data, the address of the source device and at least one of additional advertising data and an address of the re-advertising device.

The method may comprise determining, based on a value in a counter field of the first BLE advertising message, whether it is permitted to re-transmit the advertising data and address of the source device and, in response to determining that it is permitted to re-transmit the advertising data and address of the source device, forming and transmitting the second BLE advertising message. The counter field may be included in a header of the first BLE advertising message. The method may comprise including an adjusted value in a counter field of the second BLE advertising message, the adjusted value indicating a reduced number of permitted re-transmissions in respect of the advertising data the address of the source device. The counter field of the second BLE advertising message may be included in a header of the second BLE advertising message.

The method may comprise including in a field of the second advertising message an indication that the second message is a re-advertised message. The indication that the second message is a re-advertised message may be provided in a header of the second advertising message. The indication may be provided in a Packet Data Unit (PDU) Type field of the second BLE advertising message.

Forming the second BLE advertising message may comprise creating and appending cyclic redundancy check (CRC) data.

In a second aspect, this specification describes apparatus configured to be responsive to receipt of a first Bluetooth Low Energy (BLE) advertising message, the first BLE advertising message comprising advertising data and an address of a source device from which the advertising data derived, to form and cause transmission of a second BLE advertising message including the advertising data and the address of the source device.

The apparatus may be configured to encapsulate at least the advertising data and the address of the source device to form the second BLE advertising message.

The apparatus may be configured to include additional advertising data in a payload of the second BLE advertising message.

The second BLE advertising message may include an address of the apparatus. The apparatus may be configured to include the address of the apparatus in the payload second BLE advertising message.

The apparatus may be configured to determine if the first BLE advertising message includes re-transmitted advertising data and, if it is determined that the first BLE advertising includes re-transmitted advertising data, to form a payload for the second BLE advertising message which consists of the payload of the first BLE advertising message. The apparatus may be configured, if it is determined that the first BLE advertising message does not include re-transmitted advertising data, to form a payload for the second BLE advertising message which includes the advertising data, the address of the source device and at least one of additional advertising data and an address of the apparatus.

The apparatus may be configured to determine, based on a value in a counter field of the first BLE advertising message, whether it is permitted to re-transmit the advertising data and address of the source device and, in response to determining that it is permitted to re-transmit the advertising data and address of the source device, to form and transmit the second BLE advertising message. The counter field may be included in a header of the first BLE advertising message. The apparatus may be configured to include an adjusted value in a counter field of the second BLE advertising message, the adjusted value indicating a reduced number of permitted re-transmissions in respect of the advertising data the address of the source device. The counter field of the second BLE advertising message may be included in a header of the second BLE advertising message.

The apparatus may be configured to include in a field of the second advertising message an indication that the second message is a re-advertised message. The indication that the second message is a re-advertised message may be provided in a header of the second advertising message. The indication may be provided in a Packet Data Unit (PDU) Type field of the second BLE advertising message.

The apparatus may be configured to create and append cyclic redundancy check (CRC) data to form the second BLE advertising message.

In a third aspect, this specification describes computer-readable code which, when executed by computing apparatus, causes the computing apparatus to perform a method according to the first aspect.

In a fourth aspect, this specification describes a method comprising receiving a BLE advertising message including advertising data and an address of a source device from which the advertising data derived, examining a first field in the BLE advertising message to determine if the BLE advertising message includes re-transmitted advertising data and, if the BLE advertising message includes re-transmitted advertising data, disregarding the BLE advertising message.

The method may comprise determining, based on the address of the source device, if a non-re-advertised BLE advertising message has been previously received from the source device and disregarding the BLE advertising message only if the BLE advertising message is a re-advertised BLE advertising message and it is determined that a non-re-advertised BLE advertising message has been previously received from the source device.

In a fifth aspect, this specification describes apparatus configured to receive a BLE advertising message including advertising data and an address of a source device from which the advertising data derived, to examine a first field in the BLE advertising message to determine if the BLE advertising message includes re-transmitted advertising data and, if the BLE advertising message includes re-transmitted advertising data, to disregard the BLE advertising message.

The apparatus may be configured to determine, based on the address of the source device, if a non-re-advertised BLE advertising message has been previously received from the source device, and to disregard the BLE advertising message only if the BLE advertising message is a re-advertised BLE advertising message and it is determined that a non-re-advertised BLE advertising message has been previously received from the source device.

In a sixth aspect, this specification describes computer-readable code which, when executed by computing apparatus, causes the computing apparatus to perform a method according to the fourth aspect.

In a seventh aspect, this specification describes a method comprising preparing a Bluetooth Low Energy (BLE) advertising message, the BLE advertising message comprising advertising data and an address of a source device from which the advertising data derived, setting a value in a field of the BLE advertising message, the value indicating whether the advertising data and address are permitted to be re-transmitted by a recipient of the BLE advertising message and causing transmission of the BLE advertising message.

In an eighth aspect, this specification describes apparatus configured to prepare a Bluetooth Low Energy (BLE) advertising message, the BLE advertising message comprising advertising data and an address of a source device from which the advertising data derived, to set a value in a field of the BLE advertising message, the value indicating whether the advertising data and address are permitted to be re-transmitted by a recipient of the BLE advertising message, and to cause transmission of the BLE advertising message.

In a ninth aspect, this specification describes computer-readable code which, when executed by computing apparatus, causes the computing apparatus to perform a method according to the seventh aspect.

In a tenth aspect, this specification describes apparatus comprising at least one processor and at least one memory including computer program code, the at least one memory and the computer program code configured to, with the at least one processor, cause the apparatus to perform any method according to the first aspect.

In an eleventh aspect, this specification describes a non-transitory computer-readable storage medium having stored thereon computer-readable code, which, when executed by computing apparatus, causes the computing apparatus to perform a method comprising responding to receipt of a first Bluetooth Low Energy (BLE) advertising message, the first BLE advertising message comprising advertising data and an address of a source device from which the advertising data derived, by forming and causing transmission of a second BLE advertising message including the advertising data and the address of the source device.

In a twelfth aspect, this specification describes apparatus comprising at least one processor and at least one memory including computer program code, the at least one memory and the computer program code configured to, with the at least one processor, cause the apparatus to perform any method according to the fourth aspect

In a thirteenth aspect, this specification describes a non-transitory computer-readable storage medium having stored thereon computer-readable code, which, when executed by computing apparatus, causes the computing apparatus to perform a method comprising receiving a BLE advertising message including advertising data and an address of a source device from which the advertising data derived, examining a first field in the BLE advertising message to determine if the BLE advertising message includes re-transmitted advertising data and, if the BLE advertising message includes re-transmitted advertising data, disregarding the BLE advertising message.

In a fourteenth aspect, this specification describes an apparatus comprising at least one processor, and at least one memory including computer program code, the at least one memory and the computer program code configured to, with the at least one processor, cause the apparatus to perform a method according to the seventh aspect.

In a fifteenth aspect, this specification describes a non-transitory computer-readable storage medium having stored thereon computer-readable code, which, when executed by computing apparatus, causes the computing apparatus to perform a method comprising preparing a Bluetooth Low Energy (BLE) advertising message, the BLE advertising message comprising advertising data and an address of a source device from which the advertising data derived, setting a value in a field of the BLE advertising message, the value indicating whether the advertising data and address are permitted to be re-transmitted by a recipient of the BLE advertising message, and causing transmission of the BLE advertising message.

In a sixteenth aspect, this specification describes apparatus comprising means for responding to receipt of a first Bluetooth Low Energy (BLE) advertising message, the first BLE advertising message comprising advertising data and an address of a source device from which the advertising data derived, by forming and causing transmission of a second BLE advertising message including the advertising data and the address of the source device. The apparatus may further comprise means for performing any of the operations described with reference to the first aspect.

In a seventeenth aspect, this specification describes apparatus comprising means for receiving a BLE advertising message including advertising data and an address of a source device from which the advertising data derived, means for examining a first field in the BLE advertising message to determine if the BLE advertising message includes re-transmitted advertising data and means for disregarding the BLE advertising message if the BLE advertising message includes re-transmitted advertising data. The apparatus may further comprise means for performing any of the operations described with reference to the fourth aspect.

In an eighteenth aspect, this specification describes apparatus comprising means for preparing a Bluetooth Low Energy (BLE) advertising message, the BLE advertising message comprising advertising data and an address of a source device from which the advertising data derived, means for setting a value in a field of the BLE advertising message, the value indicating whether the advertising data and address are permitted to be re-transmitted by a recipient of the BLE advertising message and means for causing transmission of the BLE advertising message. The apparatus may further comprise means for performing any of the operations described with reference to the seventh aspect.

### BRIEF DESCRIPTION OF THE DRAWINGS

For a more complete understanding of examples of embodiments of the present invention, reference is now made to the following descriptions taken in connection with the accompanying drawings in which:

FIG. 1 is a simplified schematic illustrating operations of a system according examples of embodiments of the invention;

FIG. 2 is a simplified schematic illustrating examples of configurations of components which apparatuses of the system of FIG. 1 may be comprised;

FIG. 3 illustrates a format of an advertising channel message according to the current Bluetooth Low Energy (BLE) standard;

FIG. 4 illustrates examples of formats of BLE advertising messages which may be created and transmitted within the system of FIG. 1;

FIG. 5 is a flow chart showing examples of operations which may be performed by the source apparatus of FIG. 2;

FIG. 6 is a flowchart showing examples of operations which may be performed by the re-advertising apparatus of FIG. 2; and

FIG. 7 is a flowchart showing examples of operations which may be performed by the recipient apparatus of FIG. 2.

### DETAILED DESCRIPTION

In the description and drawings, like reference numerals may refer to like elements throughout.

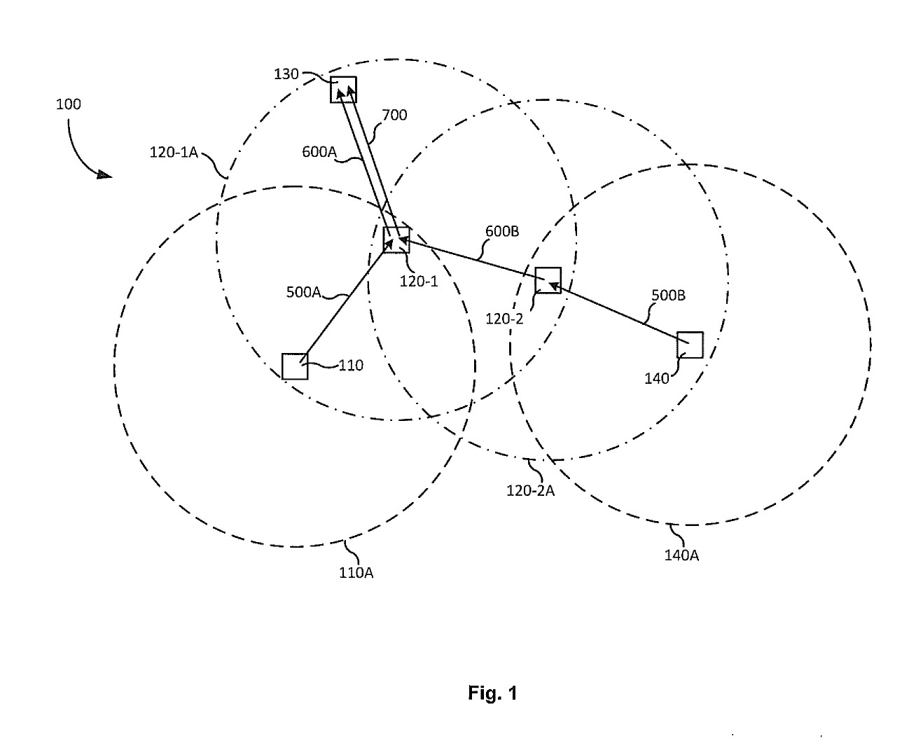

FIG. 1 shows a system including communication apparatuses according to examples of embodiments of the invention. The system 100 includes a first source device 110, a second source device 140, a first re-advertising device 120-1, a second re-advertising device 120-2 and a recipient device 130. As will be understood from the following description, in some examples the system 100 may comprise only the first source device 110, the first re-advertising device 120-1 and the recipient device 130. Similarly, in some examples, the system 100 may comprise more than one recipient device 130, more than two re-advertising devices 120-1, 120-2 and/or more than two source devices 110.

Each of the devices 110, 120-1, 120-2, 130, 140 is a Bluetooth Low Energy-capable device. That is to say, each of the devices 110, 120-1, 120-2, 130, 140 is able to operate in accordance with the BLE standard, currently at version 4.0. The transmission range of each of the source devices 110, 140 is shown by the dashed circles 110A, 140A. The transmission range of BLE devices is inherent in the current Bluetooth standard and is currently approximately 50 m.

Examples of embodiments of the invention utilise one or more of the re-advertising devices 120-1, 120-2 to extend the transmission range of source devices 110, 140. This is illustrated in FIG. 1, in which the first re-advertising device 120 allows data to be successfully transmitted via first and second BLE advertising messages 500A, 600A from a source device 110 to a recipient device 130, which is out of transmission range of the source device 110. More specifically, the first BLE message 500A is passed between the source device 110 and the first re-advertising device 120 and the second BLE message 600A is passed between the first re-advertising device 120 and the recipient device 130. It will, of course, be appreciated that the re-advertising device 120 is only able to forward data between two devices (in this example, the first source device 110 and the recipient device 130) if those devices are both within the transmission range 120A of the re-advertising device 120. The first BLE message 500A may include data derived from the source device 110 and an address of the source device 110 from which the data is derived. The address may allow the source device to be identified. The re-advertising device 120 receives the BLE message 500A and repackages at least the address and data into the second BLE message 600A which is transmitted and may subsequently be received by the recipient device 130.

In some examples, more than one re-advertising device 120-1, 120-2 may be used to communicate data between a source device 110, 140 and a recipient device 130. This further extends the transmission range of the data derived from the source device 110, 140. This can be seen in FIG. 1, in which the data and address of the second source device 140 are carried in a first BLE message 500B from the second source device 140 to the second re-advertising device 120-2, in a second BLE message 600B from the second re-advertising device 120-2 to the first re-advertising device 120-1 and, finally, in a third BLE message 700 from the first re-advertising device 120-1 to the recipient device 130.

One example of an implementation of the present invention is where the source devices 110, 140 include or are coupled to low-power sensors (for example, temperature sensors, humidity sensors, door sensors, window sensors, production line sensors etc.) arranged within a space which is larger than the transmission range of BLE-capable devices and the outputs of which require monitoring (either by human operatives or by computing apparatus). Sensor data may be packaged by each source device 110, 140, along with an address of the source device, into a BLE message 500 which is received by the re-advertising device 120-1, 120-2. The re-advertising device 120-1, 120-2 repackages the sensor data and address into a second BLE message 600, which is then transmitted. Subsequently, the second BLE message 600 is received by the monitoring (recipient) device at which the sensor data may be processed, along with the address, in any suitable way.

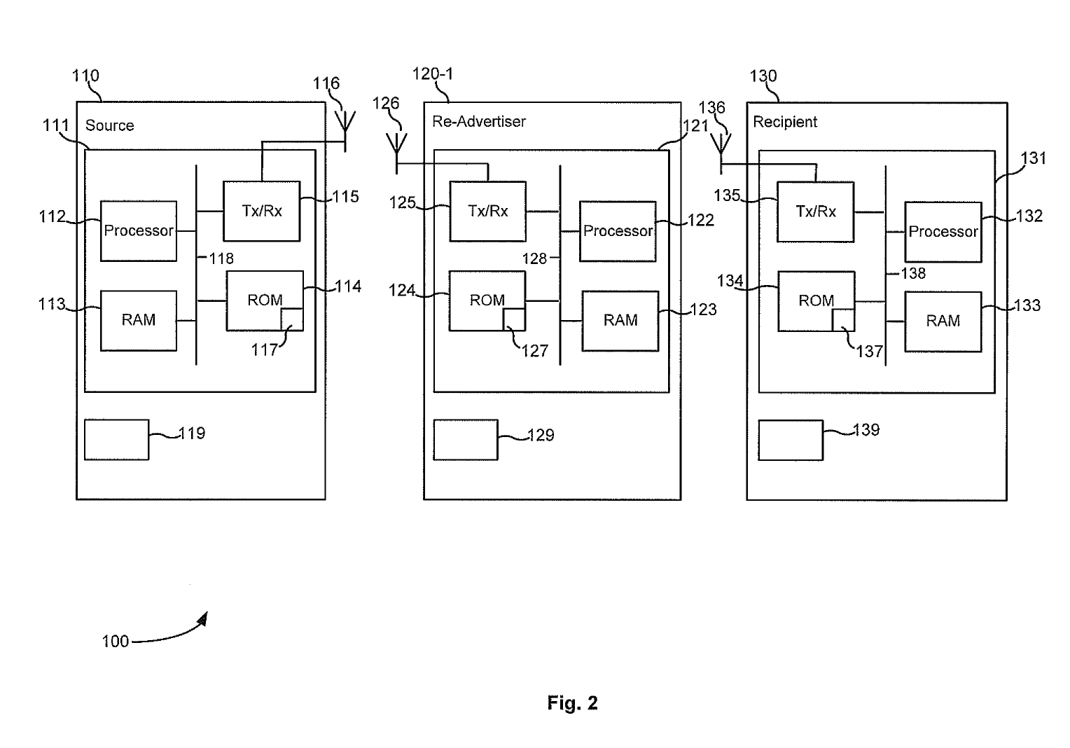

FIG. 2 is a schematic illustration showing various components of which the first source device 110, the first re-advertising device 120-1 and the recipient device 130 respectively may be comprised. The second source device 140 and the second re-advertising device 120-2 may be constituted similarly and may have similar functionality to the first source device 110 and the first re-advertising device 120-1 respectively.

The source device no includes BLE-capable apparatus 111. The BLE-capable apparatus 111 operates according to the BLE standard, currently at version 4.0. The re-advertising device 120-1 includes BLE-capable apparatus 121, which also operates according to the BLE standard. The recipient device 130 includes a BLE-capable apparatus 131, which also operates according to the BLE standard. The BLE-capable apparatuses 111, 121, 131 of each of the devices 110, 120-1, 130 are hereafter referred to as BLE modules.

The BLE module 121 of the re-advertising device 120-1 includes processing circuitry 122. The processing circuitry 122 is connected to volatile memory such as RAM 123 by a bus 128. The bus 128 also connects the processing circuitry 122 and the RAM 123 to non-volatile memory, such as ROM 124. A transceiver 125 is coupled to the bus 128, and thus also to the processing circuitry 122 and the memories 123, 124. An antenna 126 is coupled to the transceiver 125. Within the ROM 124 is stored a computer program 127. This may be in the form of firmware. Alternatively, it may be in the form of an operating system and one or more applications, for instance.

In the BLE module 111 of the source device 110, processing circuitry 112, RAM 113, ROM 114, a transceiver 115, an antenna 116, software 117 and a bus 118 may be constituted and connected in the same way as in the corresponding components of the BLE module 121 of the re-advertising device 120-1. Similarly, in the recipient module 130, the BLE module 131 may include processing circuitry 132, RAM 133, ROM 134, a transceiver 135, an antenna 136, software 137 and a bus 138 having the same functions and connections as the corresponding components in the BLE module 121 of the re-advertising device 120-1. In some examples in which receiving capability is not required, the transceiver 115 of the source device 110 may be replaced by a transmitter. Similarly, in examples in which transmitting capability is not required, the transceiver 135 of the recipient device 130 may be replaced by a receiver.

Each of the BLE modules 111, 121, 131 may take any suitable form. Generally speaking, the BLE module 121 of the re-advertising device 120-1 may comprise processing circuitry 122, including one or more processors, and a storage device 124, 123, comprising a single memory unit or a plurality of memory units. The storage device 124, 123 may store computer program instructions 127 that, when loaded into the processing circuitry 112, control the operation of the BLE module 121.

In addition to the BLE module 111, the source device 110 may comprise a number of other components which are indicated together at 119. For example, the components may include at least one sensor (for example, a temperature sensor, a humidity sensor, a door sensor, a window sensor, a production line sensors or any other type of sensor). The at least one sensor may be coupled to the processing circuitry 112 of the BLE module 111 and my provide signals (indicative of sensor data) thereto for inclusion into BLE messages. In some examples, the other components 119 may comprise an interface which is configured to couple to and receive signals (indicative of sensor data) from a sensing device (not shown). This sensor data may then be communicated to the processing circuitry 112 via the bus 118. It will be appreciated that the other components 119 may depend on the nature of the source device 110. As such, the other components may comprise any suitable combination of, for example, a display, a user input interface, a communication interface, a speaker, a microphone, and a camera. The components 119 may include a processor arrangement, a volatile memory (e.g. RAM) and non-volatile memory (e.g. ROM), connected to the processor arrangement. The re-advertising device 120-1 may comprise a number of such components which are indicated together at 129. The recipient device 130 may comprise a number of such components which are indicated together at 139.

In some examples, the re-advertising device 120-1 may comprise a low-power “BLE tag” which may be powered by, for example, a coin cell battery. In other examples, the re-advertising device may be a more complex portable or non-portable device such as a mobile phone, a smart phone, a tablet computer, a laptop computer, a personal computer or any other or apparatus into which the re-advertising functionality described herein can be incorporated.

The source device 110 may be of any suitable type, including those described above. In some examples, the source device may also be a relatively simple device including only a sensor and any necessary associated circuitry and the BLE module 111. In some examples, the source device 110 may be incorporated in or coupled with more complex computing or manufacturing apparatus.

The recipient device 130 may be of any suitable type of portable or non-portable device such as, but not limited to, a mobile phone, a smart phone, a tablet computer, a laptop computer and a personal computer. One or more of the devices 110, 120-1, 130 may be based around an operating system, for instance the Symbian operating system or Microsoft Windows operating system, although any other operating system may instead be used.

Generally speaking, embodiments of the invention allow communication of data (such as sensor data) between the source device 110 and the recipient device 130 by way of one or more re-advertising device 120-1. To achieve this, the re-advertising device 120-1, and in some examples also the source 110 device and/or the recipient device 130, operates differently to conventional BLE operation. Through the different operation, the data derived from the source device 110 may be communicated to the recipient device 130 via BLE even though the two devices may not be within range of one another such that they can not communicate via BLE directly.

Briefly, the re-advertising device 120-1 is configured to transmit a new type of BLE message, which may be a BLE advertising message or, more specifically, a BLE advertising channel packet. This may be performed in response to receiving a standard BLE advertising channel packet or an altered BLE advertising channel packet from the source device 110.

Embodiments of the present invention provide an extension to the current Bluetooth standard in that it extends the limited transmission range (of approximately 50 metres) which is inherent in the current Bluetooth standard.

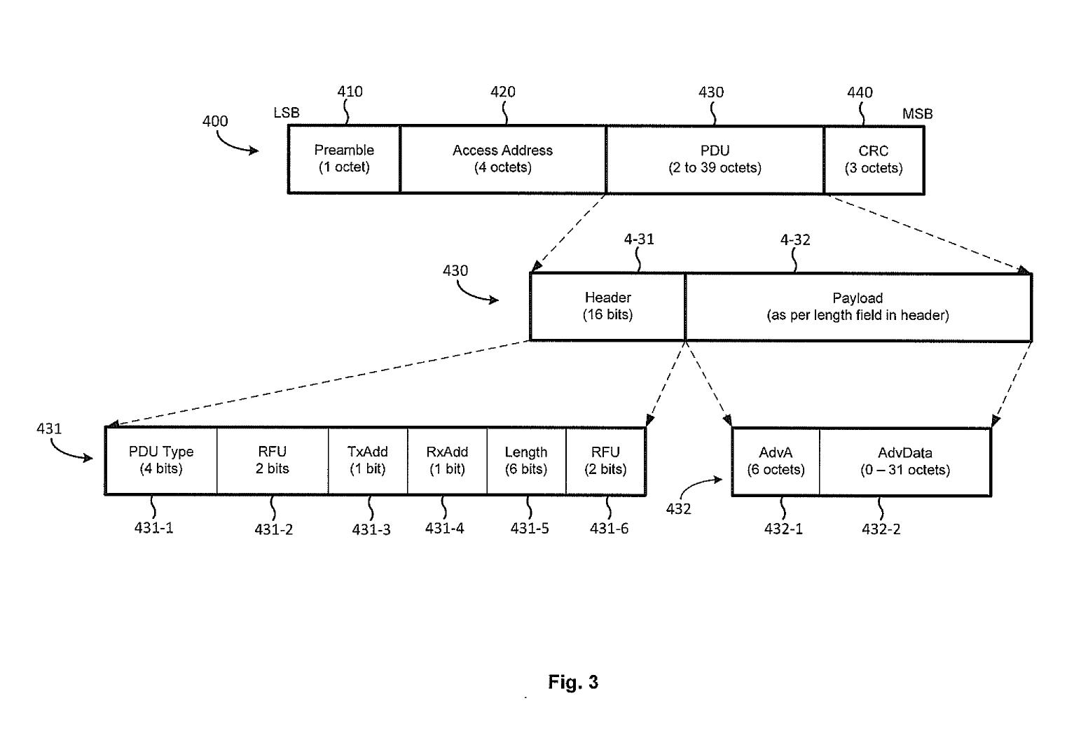

In the BLE standard, when a BLE packet is transmitted in an advertising physical channel, the packet is referred to as an advertising channel packet data unit (PDU). When a packet is transmitted in a data physical channel, the PDU is referred to as a data channel PDU. Examples of embodiments described herein utilise advertising channel PDUs. A general advertising channel PDU will now be described with reference to FIG. 3. After the general description of the advertising channel PDU, differences between the general advertising channel PDU and advertising channel PDUs according to examples of embodiments of the invention will be described.

FIG. 3 shows the format of a BLE link layer packet 400 that contains a PDU 430. The PDU 430 is encapsulated in the link layer packet 400.

As shown in FIG. 3, there are four main components to the link layer packet (also referred to as a BLE message). The first part 410 is a preamble. The second part 420 is an Access Address. The third part 430 is the packet data unit (PDU). The fourth part 440 is a cyclic redundancy check (CRC) section.

In FIG. 3, the preamble 410 is one octet (eight data bits, also known as one byte). The preamble is used in the receiver to perform frequency synchronization, symbol timing estimation, and Automatic Gain Control (AGC) training. According to the BLE standard, advertising channel packets shall have 10101010b as the preamble. The data channel packet preamble is either 10101010b or 01010101b, depending on the LSB of the Access Address 420.

The Access Address 420 is four octets. According to the BLE standard, The Access Address for all advertising channel packets is 10001110100010011011111011010110b (0x8E89BED6).

The PDU 430 is between 2 and 39 octets. The CRC 440 is three octets.

As shown in FIG. 3, the PDU 430 includes two main sections 431, 432. The first is the header 431, and the second is the payload 432. The header here has 16 bits (two octets). The payload 432 has a length that is between zero and 37 octets, as per the length field 431-5 in the header part 431 of the PDU 430.

The header 431 is shown in FIG. 3 as being divided into six fields. The PDU type field 431-1 comprises four bits. A first reserved for future use (RFU) field 431-2 comprises two bits. A TxAdd field 431-3 is one bit. An RxAdd field 431-4 is one bit. The Length (or payload length) field 431-5 includes six bits. The sixth field is a second RFU field 431-6 which includes two bits.

The RFU bits (in sections 431-2 and 431-6) in the header of the PDU are reserved for future use (RFU) in version 40.0 of the BLE specification.

The current BLE specification defines several types of advertising channel PDU, e.g., ADV_IND, ADV_DIRECT_IND, ADV_NONCONN_IND and ADV_SCAN_IND (see Bluetooth V4.0, Vol. 6, Part B, Sec. 2.3). The type of the PDU is indicated in the PDU Type field 431-1 of the header 431. For example, ADV_IND PDUs are indicated by 0000 in the PDU Type field 431-1, ADV_DIRECT_IND PDUs are indicated by 0001, ADV_NONCONN_IND PDUs are indicated by 0010 and ADV_SCAN_IND PDUs are indicated by 0110.

Different types of PDU have different payload configurations. Some of the payload configurations (including that shown in FIG. 3) include an AdvA field 432-1 (which is 6 octets long) and AdvData field 432-2 (which is 0 to 31 octets long). In the BLE standard, the AdvA field 432-2 includes the advertiser's public or random device address as indicated. The type of address included in the AdvA field 432-1 is indicated in the TxAdd section 431-3 of the header 431. The AdvData field 432-2 may contain Advertising Data from the advertiser's Host. For example, if the Host includes a sensor, the Advertising Data may include data derived from the sensor (sensor data).

Types of advertising channel PDU from the BLE standard which include the AdvA and AdvData fields 432-1, 432-2 include ADV_IND PDUs, ADV_NONCONN_IND PDUs and ADV_SCAN_IND PDUs. In some examples of embodiments, the source device 110 may be configured to prepare and transmit PDUs of a type having, in their payload, a field 432-2 including data derived from the source device 110 (which may be the AdvData field and so may be referred to as advertising data) and a field 432-1 including an address of the source device from which the data is derived (which may be the AdvA field).

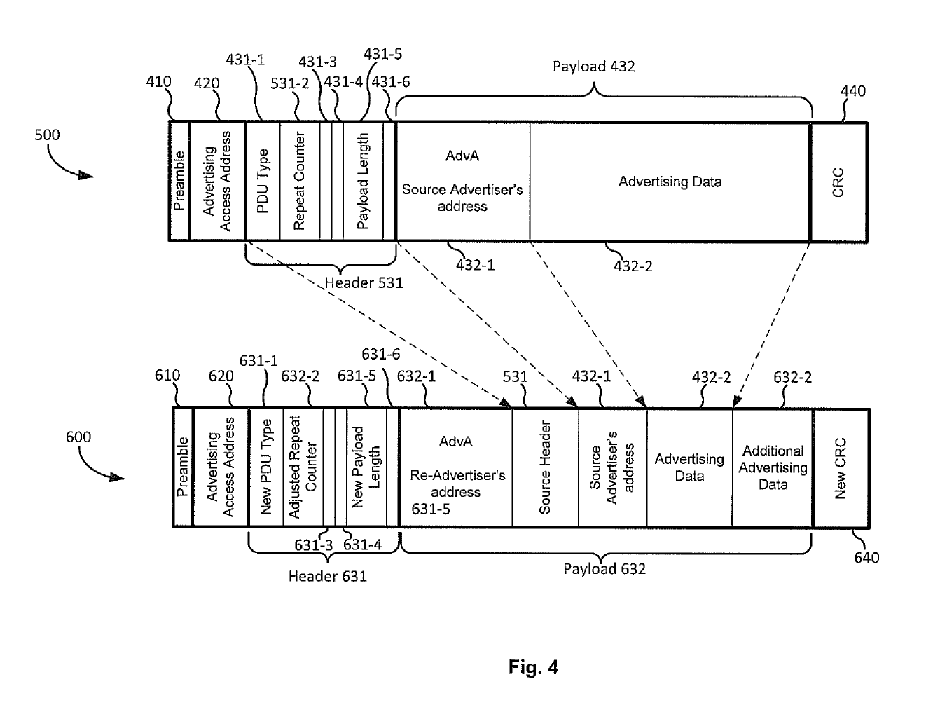

FIG. 4 shows packet formats of first and second BLE advertising messages 500, 600 (or link layer packets) in accordance with examples of embodiments of the invention. The source device 110 may be configured to prepare and transmit the first BLE message 500 and the re-advertising device 120-1 may be configured to respond to receipt of the first BLE message 500 by forming and transmitting the second BLE message 600.

Elements of the messages 500, 600 of FIG. 4 which are the same as those described with reference to FIG. 3 may have the same reference numbers.

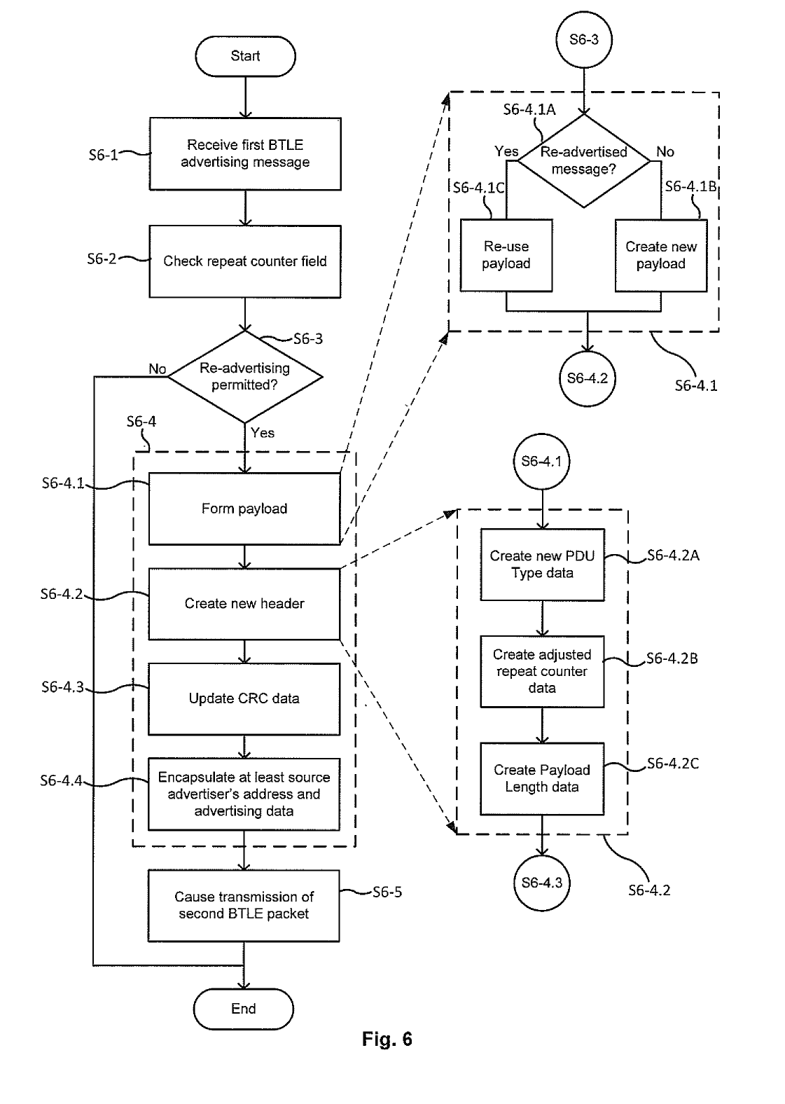

As can be seen from FIG. 4, the first message 500, which is an advertising message, includes a first field 432-2 including data derived from the source device 110 (which may be the AdvData field as per the BLE standard) and a second field 432-1 including an address of the source device from which the data is derived (which may be the AdvA field). In some examples, the format of the first BLE message 500 may be exactly as described with reference to FIG. 3. For example, the first BLE message 500 may include one of an ADV_IND PDU, an ADV_NONCONN_IND PDU and an ADV_SCAN_IND PDU. In some other examples such as that shown in FIG. 4, the PDU 531, 432 of the BLE message 500 may be substantially the same as a ADV_IND PDU, an ADV_NONCONN_IND PDU or an ADV_SCAN_IND PDU but the header 531 of the advertising channel PDU may include a “repeat” or “re-advertise” counter field 531-2. This is included in place of the one of the RFU sections shown in FIG. 3. In this particular example, the repeat counter field 531-2 is included in place of the first RFU section 431-2, although this may in some examples be included in place of the second RFU section 431-6. The source device 110 sets a value of this repeat counter 531-2 which is indicative of a number of times that the payload 432 of the first message 500 is permitted to be advertised (or, put another way, re-transmitted by another device). The function of the repeat counter 531-2 will be understood more clearly from the below discussion of the second BLE message 600 and the flow diagram of FIG. 6.

In response to receiving the first BLE message 500, the re-advertising device 120-1 may form and transmit the second BLE message 600. This may be performed automatically every time a suitable advertising message is received. Alternatively, in examples in which the first BLE advertising message 500 includes a repeat counter 531-2, the re-advertising device 120-1 may be configured to check the repeat counter 531-2 to determine if it is permitted to re-advertise the data and source address of the first message 500. For example, if the two bits of the repeat counter are set to 00 it may be determined that re-advertising is not permitted. Alternatively, 11 (or indeed 01 or 10) may indicate that re-advertising is not permitted. If it is determined that re-advertising is permitted, the re-advertising device 120-1 may then form and transmit the second (or “re-advertised”) message 600.

Transmission of the second BLE advertising message 600 may occur a predetermined duration after receipt of the first BLE advertising message 500. The duration may be, for example, between 0.1 ms and 20 ms. In some examples, it may be between 0.1 ms and toms, between 0.1 ms and 5 ms or between 0.1 ms and 1 ms. The use of a predetermined duration ensures that the re-advertising device 120-1 is transmitting BLE messages at the same advertising rate as the source device 110. In some examples, the duration may include some “jitter”, which may be purposely introduced by the re-advertising device 120-1. The jitter may be for example a random value between opts and lolls. As such, the actual transmission time of the re-advertised message by the re-advertising device 120-1 may be the duration plus or minus the magnitude of the jitter. The use of jitter may prevent repeated “collisions” of BLE messages. In other examples, the re-advertising device may not introduce any jitter. Instead, the jitter in the transmission time of the first advertising message 500A, 500B introduced by the source device 110 may ensure collisions are prevented. As such, the same interval or duration, after receipt of the first message 500A, may be used for transmission of every re-advertised message 600A, 600B, 700. This simplifies the operation of the re-advertising device 120-1, 120-2.

The second BLE message 600 comprises at least the data derived from the source device as included in the first BLE advertising message 500 (in field 432-2) and the address of the source device from which the data is derived (in field 432-2). In some embodiments, the data and the address are included in the payload 432 of the first BLE message 500 and so it may be said that the second message 600 includes the payload 432 of the first BLE message 500. The data and address (labelled as 432-2 and 432-1 respectively) may be, as shown in FIG. 4, included in the payload 632 of the second BLE message 600.

The re-advertising device 120-1 may be configured also to create a new header 631 for the PDU 631, 632 of the second BLE advertising message 600. The header 631 of the second BLE message 600 includes similar fields to the header 531 of the first message 500. For example, the header 631 includes the PDU Type field 631-1 and the payload length field 631-5. The header may also include the repeat counter field 631-3. The TxAdd, RxAdd and second RFU fields 631-3, 631-4, 631-6.

In some examples, the re-advertising device 120-1 may be configured to set the bits in the PDU Type field 631-1 to indicate a new PDU Type. Specifically, the re-advertising device 120-1 may give the second BLE message 600 a PDU Type having the following format:

| PDU Type (b₃b₂b₁b₀) | Packet Name |
|---|---|
| 0111 (or other reserved number) | ADV_RPT |

The use of such a PDU Type allows any device which receives the second BLE message 600 to determine that the message is a re-advertised message. This enables the recipient device 130 to distinguish between re-advertised messages and original messages. The recipient device may, for example, be configured to disregard re-advertised messages if it is moved into an area in which it is able to receive both original and re-advertised messages deriving from the same source device. This may be beneficial because it may prevent unnecessary processing of messages by the recipient device. This is discussed in more detail with reference to FIG. 6.

The use of the PDU Type field to indicate that a message is a re-advertised message (put another way, is a message which includes re-transmitted advertising data) is just an example of a way in which it may be indicated that the message is a re-advertised message. As will be appreciated, this indication may, in other examples, be provided in a different manner.

When creating the new header 631, the re-advertising device 120-1 may be configured to adjust the value included in the repeat counter field 531-2 of the first BLE advertising message 500 and may include the adjusted value in the repeat counter field 631-2 of the second BLE advertising message 600. For example, the re-advertising device may be configured to decrement the repeat counter value (for example, from 01 to 00, from 11 to 10, from 10 to 01, or from 11 to 00) or to increment the repeat counter value (for example, from 00 to 01, from 01 to 10, from 10 to 11 or from 00 to 11). The interval by which the value is incremented or decremented may be 1, 2 or 3. In examples in which 00 indicates that re-advertising is not permitted, the re-advertising device 120-1 may be configured to decrement the counter from its current value to an adjusted lower value. In examples in which 11 indicates that re-advertising is not permitted, the re-advertising device 120-1 may be configured to decrement the counter from its current value to an adjusted lower value.

Let us consider an example in which 00 indicates that re-advertising is not permitted and in which the decrement interval when re-advertising takes place is 1. If the source device 110 sets the value of the repeat counter to 11, this indicates that the source advertising data and address of the first BLE advertising message 500 are permitted to be re-advertised three times, 10 indicates that re-advertising twice is allowed and 01 indicates that only one re-advertising operation is permitted.

The use of the repeat counter ensures, for example, that the re-advertised data is not unnecessarily re-transmitted back and forth between re-advertising devices 120-1, thereby conserving power, processing resources and bandwidth. For example, if the recipient device 130 is 125 metres from the source device 110 (bearing in mind the current transmission range of 50 metres of BLE-capable devices), the system 100 may comprise two re-advertising devices 120-1, 120-2. In such a system, two re-transmission operations may be required in order to ensure data is passed from the source 110 to the recipient 130. As such, the source device 110 may set the repeat counter value in the first BLE advertising message to 10. Subsequently, when re-transmitting the advertising data, the first re-advertising device 120-1 may adjust the value in the second BLE advertising message to 01. The second re-advertising device 120-2 then sets the repeat counter value in the third BLE message to 00, which indicates that re-transmission is not permitted. Consequently, if the third BLE message is subsequently received by the first re-advertising device, it will recognize that it is not permitted to re-transmit the advertising data.

Returning now to FIG. 4, the re-advertising device 120-1 may be configured to include its own address in a field 632-1 of the second BLE advertising message. This may be included, for example, in the payload 632. More specifically, this may be included in an “AdvA” field 632-1 of the payload 632. The remaining data (including the source-derived data and the source address) may be included in the “AdvData” field of the payload 632.

The re-advertising device 120-1 may also be configured to include additional advertising data 632-2 in the second BLE message 600. This data may derive from the re-advertising device 120-1 (for example, if the re-advertising device is coupled to its own sensor) or may derive from another source device. For example, the re-advertising device 120-1 may be configured to incorporate advertising data and the address derived from the first source device 110 into the second BLE message 600 along with data and an address derived from the second source device 150 (see FIG. 1).

In addition to the source device-derived data 432-2 and the source address 432-1, the second BLE advertising message 600 may also include at least some of the header 531 from the first BLE advertising message 500. For example, at least the payload length field 431-5 may be included. This may enable the recipient device 130 to successfully distinguish the re-advertised address and data from the additional data added by the re-advertising device 120-1. The original PDU Type field 431-1 from the header of the first BLE advertising message 500 may also be included in the second BLE advertising message 600. This may provide the recipient device 130 with an indication as to how the data derived from the source device 110 (which is included in the second message 600) should be handled. In some examples, the entire header 531 of the first message 500 is included in the second message 600.

After forming the PDU 631, 632 of the second BLE advertising message 600, the re-advertising device 120-1 encapsulates the PDU 631, 632 to form a link layer packet. The link layer packet includes a preamble 610 and advertising access address 620 as described with reference to FIG. 3. The link layer packet includes also includes new CRC data 640 appended to the PDU 631, 632.

In some examples, the re-advertising device 120-1, 120-2 may be configured to determine if a received message is a re-advertised message (i.e. is received from a re-advertising device). This may be performed by checking the PDU Type field 431-1, 631-1. The re-advertising device may be configured to handle re-advertised messages differently to non-re-advertised (or original) messages. More specifically, if the re-advertising device 120-1 determines that a received message is not a re-advertised message, it may operate as described above by including its address and/or additional data in the payload of a re-advertised message for transmission. This may be in addition to changing the PDU Type and adjusting the value indicated by the repeat counter, if one is present. If the re-advertising device 120-1 determines that a received message is a re-advertised message, the re-advertising device 120-1 may not alter the payload of the received message and may instead form and transmit a message having the same payload as the received message. The re-advertising device 120-1 may, however, adjust the repeat counter 632-2 in the header 631. The payload and header may then be encapsulated and transmitted.

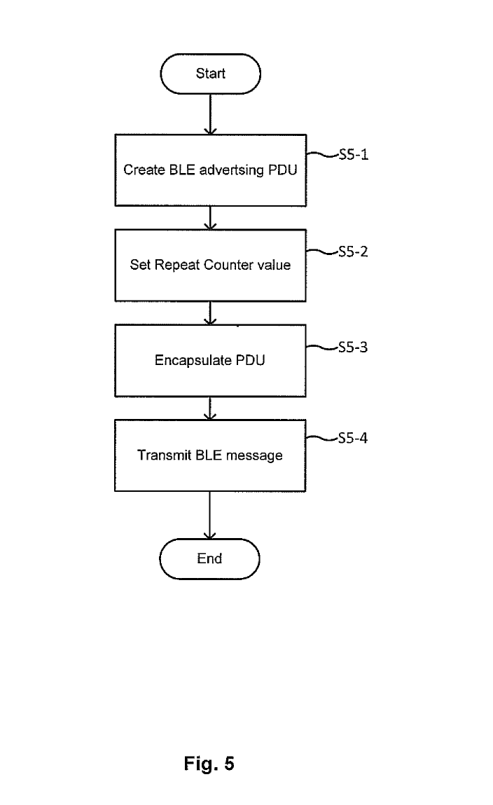

FIG. 5 is a flow chart depicting a various operations which may be performed by the source device 110 according to examples of embodiments.

In operation S5-1, the processing circuitry 112 of the source device 110 creates the PDU 531, 432 of the first BLE advertising message 500. This comprises creating the payload 432 including the advertising data 432-2 and the source advertiser's address 432-1. In addition creation of the PDU 531 comprises creating the header section 531. This comprises creating and setting the PDU Type field 431-1 and the payload length field 431-5. The PDU Type field may be set to indicate for example one of an ADV_IND PDU, an ADV_NONCONN_IND PDU and an ADV_SCAN_IND PDU.

In operation S5-2, which may be part of operation S5-1 (creation of the header section), the processing circuitry 112 sets the value of the repeat counter field 531-2. This value indicates to a recipient re-advertising device (e.g. device 120-1) whether or not the payload (at least) of the first message 500 is permitted to be re-advertised or, put another way, re-transmitted in another BLE advertising message.

In operation S5-3, the processing circuitry 112 encapsulates the created PDU 531, 432. This may comprise creating CRC data 440 and appending this to the PDU 531, 432. In addition, the processing circuitry 112 creates the preamble section 410 and the Advertising Access Address section 420 and pre-fixes this to the PDU 531, 432.

Finally, in operation S5-4, the processing circuitry 112 causes the first BLE advertising message 500 to be transmitted, via the transceiver 115 and antenna 116, on one of the advertising channels.

It will be appreciated that, in some examples in which the repeat counter field is not included in the first BLE advertising message 500, operation S5-2 of setting the value of the repeat counter 531-2 may be omitted.

FIG. 6 is a flow chart depicting a various operations which may be performed by the re-advertising device 120-1 in accordance with examples of embodiments.

In operation S6-1, the re-advertising device 120-1 receives the first BLE advertising message 500 from the source device 120-1 (or in some examples from another re-advertising device). The first BLE message 500 is received via the antenna 126 and the transceiver 125 of the BLE module 121. Prior to receiving the first BLE message 500, the BLE module 121 of the re-advertising device 120-1 is maintained in a listening state (for example, the “passive scanning state” as described in Volume 6, Part D-40.1 of the Bluetooth Standard).

In operation S6-2, in response to receipt of the first BLE message 500, the processing circuitry 122, under the control of the computer-readable code 127, checks the repeat counter field 531-2 of the first BLE message 500. In operation S6-3, the processing circuitry 122 determines, based on the repeat counter field 531-2, whether re-advertising of source-derived data 432-2 and the source address 432-1 of the first BLE message 500 is permitted. This may comprise determining if a value of the repeat counter 531-2 is at a particular value which is recognised as indicating that re-advertising is not permitted. As mentioned above, the value 00, for example, may indicate that re-advertising is not permitted.

If it is determined that re-advertising is not permitted, re-advertising device 120-1 may take no further action and the method may end.

If it is determined that re-advertising is permitted, the processing circuitry 122, in operation S6-4, forms the second BLE advertising message 600. The second BLE message 600 includes at least the source-derived data 432-2 and source device address 432-1 from the first BLE message 500.

Forming the second BLE message 600 comprises, in operation S6-4.1, forming the payload 632 of the second message 600. This may comprise, in operation S6-4.1A, determining whether the received message 500 is a re-advertised message. This may be performed by checking the PDU Type field 431-1, 631-1 of the received first message 500. If the PDU Type field 431-1, 631-1 indicates that the PDU is an ADV_RPT-type PDU, it may be determined that the message is a re-advertised message. If the PDU Type field 431-1, 631-1 indicates that the PDU is other than an ADV_RPT-type PDU, it may be determined that the message is an original (or non-re-advertised) message.

If it is determined that the message is not a re-advertised message, the flow proceeds to operation S6.40.1B in which the processing circuitry 122 creates a new payload for transmission in a second message 600. This may comprise prefixing the address of the re-advertiser 632-1 to the payload 432 of the first BLE advertising message 500, for example, in the AdvA field of the advertising payload. In some examples, creating the payload 632 may comprise appending additional advertising data 632-2 to the payload 432 of the first message 500. In addition to the AdvData and the AdvA field extracted from the first BLE message 500, the payload 632 of the second message may also comprise the header section 531 of the first BLE message 500.

If it is determined that the message is a re-advertised message, the flow proceeds to operation S6.40.1C in which the processing circuitry 122 re-uses the payload of the received message 500 as the payload of the second message 600. Put another way, the payload of the second message 600 may consist exclusively of the payload of the received first message 500. In such examples, the payload of the second message 600 does not include any additional data included by the re-advertising device 120-1 nor does it include the address of the re-advertising device 120-1. This ensures that the length of re-advertised messages remains the same after the first re-advertising operation in respect of the advertising data and the address of the source device 110 from which the advertising data is derived.

After either of operations S6.40.1C and S6.4.1B, the flow proceeds to S6-40.2.

In operation S6-4.2, the new header section 631 of the PDU 631, 632 of the second message 600 is created by the processing circuitry 122. Creating the header section 631 may comprise, in operation S6-40.2A, setting the bits of the PDU Type section 631-1 to indicate that the PDU is an ADV_RPT-type PDU (e.g. that the PDU includes re-advertised data). Creating the header section 631 may comprise, in operation S6-4.2A, setting the adjusted repeat counter 632-2 value. Creating the header 631 also comprises, in operation S6-40.2C, setting the Payload Length field 631-5 to indicate the payload length.

Forming the second BLE message 600 may also comprise, in operation S6-4.3, creating new CRC data 640. Forming the second BLE message 600 also comprises encapsulating the source-derived data 432-2 and the source device address 432-1.

Encapsulating may comprise creating a preamble 610 and an Advertising Access Address section 620, prefixing these to the PDU 631, 632 and also appending the new CRC data.

Subsequent to forming the second BLE advertising message 600, in operation S6-5, the processing circuitry 122 causes the second BLE advertising message 600 to be transmitted on one of the advertising channels via the transceiver 125 and antenna 126.

Subsequent to transmitting the second BLE message 600, the re-advertising device 120-1 may return to a listening state.

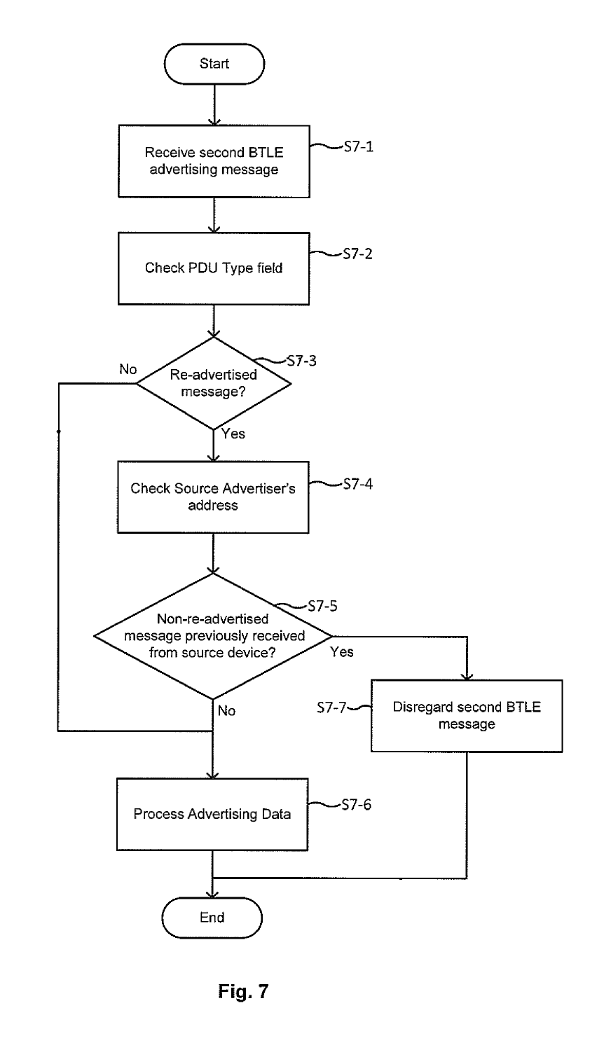

FIG. 7 is a flow chart depicting a various operations which may be performed by the recipient device 130 in accordance with examples of embodiments.

In operation S7-1, the recipient device receives a BLE advertising message.

In operation S7-2, the processing circuitry 132 checks the PDU Type field e.g. 632-1. In operation S7-3, the processing circuitry 132 determines if the received message is a re-re-advertised message 600. For example, it may be determined whether or not the PDU Type is ADV_RPT. If the PDU Type field indicates ADV_RPT, the message may be determined to be a re-advertised message 600. If the PDU Type field indicates a type other than ADV_RPT, the message may be determined not to be a re-advertised message.

If the message is determined not to be a re-advertised message 600, the flow proceeds to operation S7-6, in which the message, including the advertising data, is processed.

If the message is determined to be a re-advertised message 600, the flow proceeds to step S7-4 in which the processing circuitry 132 checks the address of the source device 432-1, which is included in the payload 632 of the message 600.

Next, in step S7-5, it is determined if a non-re-advertised message has been received from the source device identified by the source address. The recipient device may maintain a record of source devices from which messages are derived and also whether the messages are re-advertised or not. If a non-re-advertised message has been received from the same source device, for example within a certain time period, the processing circuitry may disregard the re-advertised message 600. This can be seen in operation S7-7. Alternatively, if it is determined that a non-re-advertised message has not been received from the same source device, the re-advertised message 600 including the advertising data is processed. This can be seen in operation S7-6.

It will be appreciated that the flow charts of FIGS. 5 to 7 are examples only and that certain operations may be performed in different orders to those shown. Similarly, certain operations may be omitted. For example, in FIG. 6, steps S6-40.1A and S6-4.1C may be omitted. As such, forming the payload of the re-advertised message may comprise only operation S6-4.1B.

Some further details of components and features of the above-described devices and alternatives for them will now be described.

The computer program instructions 117, 127, 137 may provide the logic and routines that enables the respective BLE module 111, 121, 131 to perform the functionality described above. The computer program instructions 117, 127, 137 may be pre-programmed into the BLE module 111, 121, 131. Alternatively, they may arrive at the BLE module 111, 121, 131 via an electromagnetic carrier signal or be copied from a physical entity such as a computer program product, a non-volatile electronic memory device (e.g. flash memory) or a record medium such as a CD-ROM or DVD.

The processing circuitry 112, 122, 132 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 112 may be termed processing means.

Typically, the BLE module 111, 121, 131 comprises at least one processor 112, 122, 132 coupled connected to both volatile memory 113, 123, 133 and non-volatile memory 114, 124, 134. The computer program is stored in the non-volatile memory 114, 124, 134 and is executed by the processor 112, 122, 132 using the volatile memory 113, 123, 133 for temporary storage of data or data and instructions. Examples of volatile memory include RAM, DRAM, SDRAM etc. Examples of non-volatile memory include ROM, PROM, EEPROM, flash memory, optical storage, magnetic storage, etc.

The BLE module 111, 121, 131 may be a single integrated circuit. It may alternatively be provided as a set of integrated circuits (i.e. a chipset). The BLE module 111, 121, 131 may alternatively be a hardwired, application-specific integrated circuit (ASIC).

The additional components 119, 129, 139, if there are any, may be arranged in any suitable way. For instance, there may be provided processing circuitry, including one or more processors, and a storage device, comprising a single memory unit or a plurality of memory units. The processing circuitry may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 112 may be termed processing means. The storage device may store computer program instructions that, when loaded into the processing circuitry, control the operation of the respect device 110, 120-1, 130. The computer program instructions may provide the logic and routines that enables the device 110, 120-1, 130 to provide functions of the device that are not provided by the BLE module 111, 121, 131 on its own. The computer program instructions may be pre-programmed into the client device 110, 120-1, 130. Alternatively, they may arrive at the client device 110, 120-1, 130 via an electromagnetic carrier signal or be copied from a physical entity such as a computer program product, a non-volatile electronic memory device (e.g. flash memory) or a record medium such as a CD-ROM or DVD.

Typically, the components 119 of the client device no comprises a processor coupled connected to both volatile memory and non-volatile memory. The computer program is stored in the non-volatile memory and is executed by the processor using the volatile memory for temporary storage of data or data and instructions. Examples of volatile memory include RAM, DRAM, SDRAM etc. Examples of non-volatile memory include ROM, PROM, EEPROM, flash memory, optical storage, magnetic storage, etc.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories.

The communication interface may be configured to allow two-way communication with external devices and/or networks. The communication interface may be configured to communicate wirelessly via one or more of several protocols such as Global System for Mobile Communications (GSM), Code Division Multiple Access (CDMA), Universal Mobile Telecommunications System (UMTS) and IEEE 802.11 (Wi-Fi). Alternatively or additionally, the communication interface 114 may be configured for wired communication with a device or network.

The apparatus may comprise further optional SW components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

Any of the computer programs described above, may be implemented in a computer program product comprising a tangible computer-readable medium bearing computer program code embodied therein which can be used with the processor for the implementation of the functions described above.

The computer program instructions may arrive at the apparatus via an electromagnetic carrier signal or be copied from a physical entity such as a computer program product, a memory device or a record medium such as but not exclusively a CD-ROM or DVD, and/or an article of manufacture that tangibly embodies the computer program.

Reference to “computer-readable storage medium”, “computer program product”, “tangibly embodied computer program” etc, or a “processor” or “processing circuitry” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-60. (canceled)

61. An apparatus comprising:
at least one processor; and
at least one memory including computer program code, the at least one memory and the computer program code configured to, with the at least one processor, cause the apparatus at least:
to be responsive to receipt of a first Bluetooth Low Energy (BLE) advertising message, the first BLE advertising message comprising advertising data and an address of a source device from which the advertising data derived, to form and cause transmission of a second BLE advertising message including the advertising data and the address of the source device.

62. The apparatus of claim 61, the at least one memory and the computer program code being configured to, with the at least one processor, cause the apparatus to encapsulate at least the advertising data and the address of the source device to form the second BLE advertising message.

63. The apparatus of claim 61, the at least one memory and the computer program code being configured to, with the at least one processor, cause the apparatus to include additional advertising data in a payload of the second BLE advertising message.

64. The apparatus of claim 61, wherein the second BLE advertising message includes an address of the apparatus.

65. The apparatus of claim 61, the at least one memory and the computer program code being configured to, with the at least one processor, cause the apparatus to include an address of the apparatus in the payload of the second BLE advertising message.

66. The apparatus of claim 61, the at least one memory and the computer program code being configured to, with the at least one processor, cause the apparatus:
to determine if the first BLE advertising message includes re-transmitted advertising data; and
if it is determined that the first BLE advertising includes re-transmitted advertising data, to form a payload for the second BLE advertising message which consists of the payload of the first BLE advertising message.

67. The apparatus of claim 66, the at least one memory and the computer program code being configured to, with the at least one processor, cause the apparatus:
if it is determined that the first BLE advertising message does not include re-transmitted advertising data, to form a payload for the second BLE advertising message which includes the advertising data, the address of the source device and at least one of additional advertising data and an address of the apparatus.

68. The apparatus of claim 61, the at least one memory and the computer program code being configured to, with the at least one processor, cause the apparatus:
to determine, based on a value in a counter field of the first BLE advertising message, whether it is permitted to re-transmit the advertising data and address of the source device; and
in response to determining that it is permitted to re-transmit the advertising data and address of the source device, to form and transmit the second BLE advertising message.

69. The apparatus of claim 68 wherein the counter field is included in a header of the first BLE advertising message.

70. The apparatus of claim 68, the at least one memory and the computer program code being configured to, with the at least one processor, cause the apparatus to include an adjusted value in a counter field of the second BLE advertising message, the adjusted value indicating a reduced number of permitted re-transmissions in respect of the advertising data the address of the source device.

71. The apparatus of claim 70, wherein the counter field of the second BLE advertising message is included in a header of the second BLE advertising message.

72. The apparatus of claim 61, the at least one memory and the computer program code being configured to, with the at least one processor, cause the apparatus to include in a field of the second advertising message an indication that the second message is a re-advertised message.

73. An apparatus comprising:
at least one processor; and
at least one memory including computer program code, the at least one memory and the computer program code configured to, with the at least one processor, cause the apparatus at least:
to receive a BLE advertising message including advertising data and an address of a source device from which the advertising data derived;
to examine a first field in the BLE advertising message to determine if the BLE advertising message includes re-transmitted advertising data; and
if the BLE advertising message includes re-transmitted advertising data, to disregard the BLE advertising message.

74. The apparatus of claim 73, the at least one memory and the computer program code being configured to, with the at least one processor, cause the apparatus:
to determine, based on the address of the source device, if a non-re-advertised BLE advertising message has been previously received from the source device; and
to disregard the BLE advertising message only if the BLE advertising message is a re-advertised BLE advertising message and it is determined that a non-re-advertised BLE advertising message has been previously received from the source device.

75. The apparatus of claim 73, the at least one memory and the computer program code being configured to, with the at least one processor, cause the apparatus:
to determine, based on a value in a counter field of the BLE advertising message, whether it is permitted to retransmit the BLE advertising data and the address of the source device; and
in response to determining that it is permitted, to re-transmit the BLE advertising message, wherein the counter has been updated.

76. An apparatus comprising:
at least one processor; and
at least one memory including computer program code, the at least one memory and the computer program code configured to, with the at least one processor, cause the apparatus at least:
to prepare a Bluetooth Low Energy (BLE) advertising message, the BLE advertising message comprising advertising data and an address of a source device from which the advertising data derived;
to set a value in a field of the BLE advertising message, the value indicating whether the advertising data and address are permitted to be re-transmitted by a recipient of the BLE advertising message; and
to cause transmission of the BLE advertising message.
